(19) United States
(12) Patent Application Publication
(10) Pub. No.: US 2014/0204221 A1
(43) Pub. Date: Jul. 24, 2014

(54) Imaging Unit, Apparatus Comprising an Imaging Unit, a System, and Methods for Calibrating an Imaging Apparatus Optimization

(71) Applicant: Nokia Corporation, Espoo (FI)

(72) Inventors: Mikko J. Muukki, Tampere (FI); Jarno Nikkanen, Tampere (FI)

(73) Assignee: Nokia Corporation, Espoo (FI)

(21) Appl. No.: 14/221,365

(22) Filed: Mar. 21, 2014

Related U.S. Application Data
(62) Division of application No. 12/386,812, filed on Apr. 23, 2009.

(51) Int. Cl. H04N 17/00; H04N 5/76; H04N 5/357

(52) U.S. Cl. CPC H04N 17/002; H04N 5/3572; H04N 5/76
USPC 348/187; 348/231.3

(57) ABSTRACT

Improved systems and techniques for calibrating an electronic imaging module are described. An electronic imaging module is subjected to a stimulus and properties of the stimulus are measured. Calibration data associated with the electronic imaging module is stored. The calibration data comprises calibration data indicative of a response of the electronic imaging module to the stimulus, as well as calibration data indicative of the measured properties of the stimulus.

### CROSS-REFERENCE TO RELATED APPLICATIONS

This application claims priority as a divisional application of U.S. patent application Ser. No. 12/386,812, filed Apr. 23, 2009, which is incorporated herein by reference in its entirety

### TECHNICAL FIELD

The invention concerns generally electronic apparatuses that include imaging functionality. Exemplary embodiments of the invention involve an electronic imaging module, an electronic imaging device, a calibration apparatus, and methods and computer programs for execution and implementation in devices of said kind.

### BACKGROUND

Digital imaging is performed with an electronic imaging device, which records the exposure of a pixelized semiconductor image sensor array to electromagnetic radiation (for example visible light) and stores the recorded pixel-specific exposure values to a digital memory. Despite the large-scale mass manufacturing of the components of the digital imaging devices, individual differences occur in the characteristics of completed devices. Known types of individual artefacts that may occur include, but are not limited to, pixel defects, pixel defect groups, lens shading, spectral responsiveness of the image sensor or parts of it, and zooming accuracy.

A calibration memory can be used to store device-specific calibration data, which is then available for use to correct the raw image obtained with an electronic imaging device. A calibration process may comprise applying a set of known and controlled test conditions to an imaging module (and/or an electronic imaging device that includes an imaging module), observing the sets of stored pixel-specific exposure values, comparing them to what they should be according to the known test conditions, and storing information about noticed discrepancies.

### SUMMARY

This summary of some examples of the invention is intended to merely exemplary and non-limiting.

An advantage of a number of exemplary embodiments of the invention is the provision of a flexible way of utilising a calibration memory, so that it effectively responds to the need for storing different kinds of calibration data in association with individual imaging modules and/or electronic imaging devices. Another advantage of a number of exemplary embodiments of the invention is the provision of a calibration memory solution for an imaging module and/or electronic imaging device that is readily applicable to a number of different purposes.

Another advantage of a number of exemplary embodiments of the invention is the provision of compensation for unintended changes in calibration conditions.

Other advantages of these and other embodiments of the inventions are discussed later in this description.

An apparatus of the type of an electronic imaging module according to one exemplary embodiment of the invention comprises an electronic imaging module, a calibration memory comprising stored calibration data indicative of specific characteristics of said electronic imaging module, and at least one register comprising stored allocation data indicative of composition of said stored calibration data.

An apparatus of the type of a calibration apparatus according to one exemplary embodiment of the invention comprises a calibration data allocator configured to determine a specific allocation of storage space for at least one type of calibration data indicative of specific characteristics of an electronic imaging module and to compose allocation data indicative of composition of said calibration data, a calibration data writer configured to store said calibration data, and an allocation data handler configured to effect storing of said allocation data.

A calibration method according to one exemplary embodiment of the invention comprises determining a specific allocation of storage space for at least one type of calibration data indicative of specific characteristics of an electronic imaging module, composing allocation data indicative of composition of said calibration data, storing said calibration data, and storing said allocation data.

A computer-readable medium comprising software instructions that are configured to make a processor implement a calibration method according to one exemplary embodiment of the invention are configured to make said processor determine a specific allocation of storage space for at least one type of calibration data indicative of specific characteristics of an electronic imaging module, compose allocation data indicative of composition of said calibration data, store said calibration data, and store said allocation data.

An apparatus of the type comprising an imaging module according to one exemplary embodiment of the invention comprises an interface for exchanging digital data with an electronic imaging module, a calibration data reader configured to read calibration data through said interface, and an allocation data reader configured to read allocation data indicative of composition of said calibration data and to control the reading of said calibration data on the basis of read allocation data.

A method for operating an apparatus that comprises an imaging module according to one exemplary embodiment of the invention comprises reading allocation data indicative of composition of calibration data, and reading calibration data from a calibration memory associated with an imaging module in an order determined by said allocation data.

A computer-readable medium comprising software instructions that are configured to make a processor implement a method for operating an apparatus that comprises an imaging module according to one exemplary embodiment of the invention are configured to make the processor read allocation data indicative of composition of calibration data, and read calibration data from a calibration memory associated with an imaging module in an order determined by said allocation data.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

### BRIEF DESCRIPTION OF THE DRAWINGS

FIG. 1 illustrates a group of electronic imaging modules;

FIG. 2 illustrates another group of electronic imaging modules;

FIG. 3 illustrates a group of electronic imaging devices;

FIG. 4 illustrates an electronic imaging module;

FIG. 5 illustrates an electronic imaging device;

FIG. 6 illustrates a calibration apparatus;

FIG. 7a illustrates a method and a computer program product;

FIG. 7b illustrates a method and a computer program product;

FIG. 8 illustrates an electronic imaging device;

FIG. 9 illustrates a method and a computer program product;

FIG. 10 illustrates a method and a computer program product;

FIG. 11 illustrates a calibration apparatus; and

FIG. 12 illustrates a method and a computer program product.

### DETAILED DESCRIPTION

In the following description we use the term “electronic imaging module” in general to refer to an apparatus that comprises components designed for digital imaging, and that is configured for use as an integral part of a larger assembled entity. Said larger entity is designated here with the term “electronic imaging device”. An apparatus that is configured for use in controllably subjecting an imaging module and/or an electronic imaging device to a set of test conditions and recording calibration data, is designated with the term “calibration apparatus”. A data storage that is configured to store calibration data specific to a particular imaging module and/or electronic imaging device is designated with the term “calibration memory”. It is advantageous, but not mandatory, that the calibration memory constitutes a part of the imaging module and/or the electronic imaging device the calibration data of which it contains or is to contain.

As a non-limiting example, an electronic imaging device may be a portable communications device, and an electronic imaging module may be a camera module that the manufacturer of portable communications devices obtains from a subcontractor and uses as one of the parts to be assembled together to manufacture a complete portable communications device.

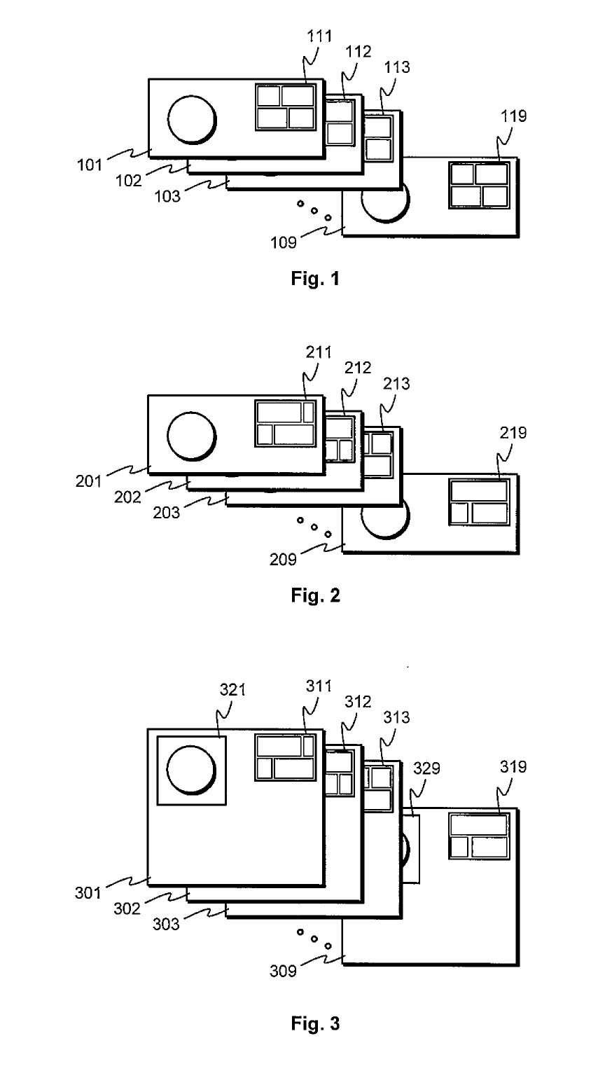

FIG. 1 illustrates schematically a group of electronic imaging modules 101, 102, 103, . . . , 109, each of which comprises an associated calibration memory 111, 112, 113, . . . 119. Each calibration memory has been divided in the same way into storage areas for different kinds of calibration data, indicated schematically in FIG. 1 as empty blocks. A consequence of the similar division of storage areas of each calibration memory is a certain degree of inflexibility. For example, let us assume that imaging module 101 comprises a relatively severe lens shading artefact but practically no pixel defects at all, while imaging module 102 comprises a large number of pixel defects but a practically perfect lens. It may happen that the storage area fixedly reserved for lens shading data in calibration memory 111 is not quite sufficient to properly calibrate for the lens shading. Similarly it may happen that the storage area fixedly reserved for pixel defect data in calibration memory 112 is not quite large enough to store proper calibration data of all pixel defects. Simultaneously there may be ample space free in other storage areas of calibration memories 111 and 112.

FIG. 2 illustrates schematically a group of electronic imaging modules 201, 202, 203, . . . , 209, each of which comprises an associated calibration memory 211, 212, 213, . . . 219. This time the division of the calibration memories into storage areas is not fixed. For example, calibration memory 211 is clearly divided into storage areas in a different way than calibration memory 219.

An advantage of having the calibration memories non-fixedly divided into storage areas is a certain degree of flexibility. Imitating the example used above, we may assume that imaging module 201 is one with a severe lens shading artefact and no pixel defects, and imaging module 202 is one with a large number of pixel defects and a perfect lens. The division into storage areas of calibration memory 211 may be such that there is a relatively large storage area available for storing lens shading data, and a small or even non-existent storage area for calibration data of pixel defects. Similarly the division into storage areas of calibration memory 212 may be such that there is a relatively large storage area available for storing calibration data of pixel defects, and little or no storage area available for storing lens shading data.

FIG. 3 illustrates schematically a group of electronic imaging devices 301, 302, 303, . . . , 309, each of which comprises a calibration memory 311, 312, 313, . . . 319 associated with an electronic imaging module that is also comprised by the electronic imaging device. As examples, electronic imaging modules 321 and 329 are shown. In each case the calibration memory is integral to the electronic imaging device but external to the imaging module.

Again the division of the calibration memories into storage areas is not fixed. For example, calibration memory 311 is clearly divided into storage areas in a different way than calibration memory 319. A calibration memory may be implemented as a part of a larger data storage comprised by an electronic imaging device, or it may be a specific component received specifically for storing calibration data in the assembled configuration of an electronic imaging device.

We may assume that since the division into storage areas of a particular calibration memory should reflect the imaging-module-specific need for storage space for different kinds of calibration data, the allocation of storage space in the calibration memory is not (completely) known before calibrating a particular imaging module. Instead, the allocation of storage space in the calibration memory is made dynamically in the course of a calibration process. A programmable electronic imaging device—or, from the software viewpoint, the software program that controls the operations of an electronic imaging device—should be able to determine, what is the allocation of calibration data used for that particular electronic imaging module that constitutes a part of the electronic imaging device.

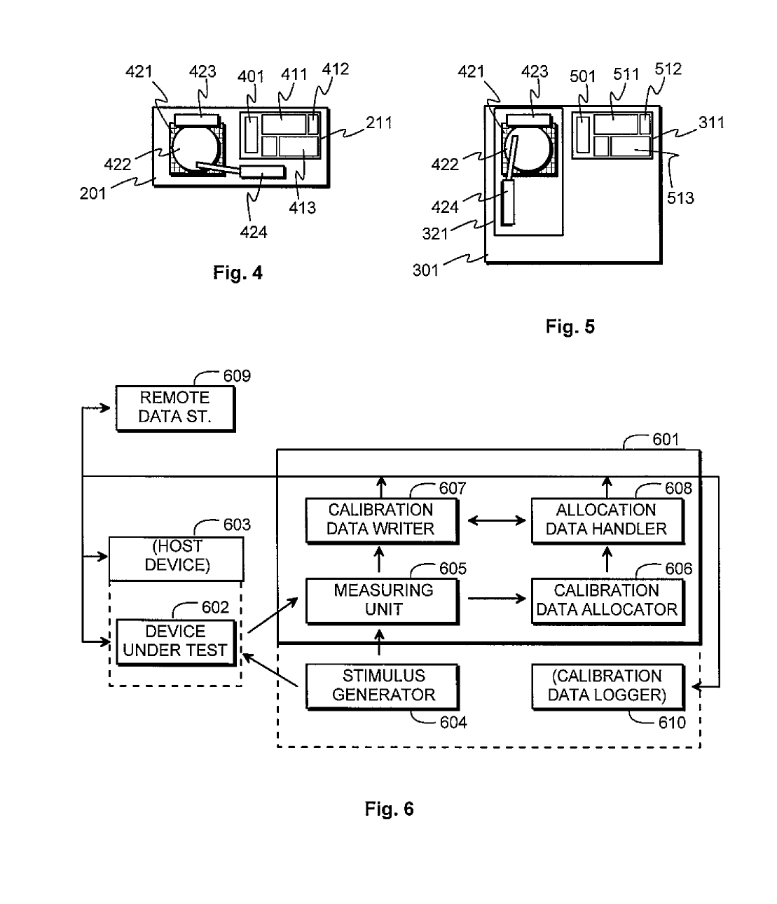

FIG. 4 illustrates the use of a register to indicate the composition of stored calibration data. An apparatus according to an embodiment of the invention comprises an electronic imaging module 201, which comprises a calibration memory 211 with stored calibration data indicative of specific characteristics of the electronic imaging module 201. At least one register 401 is provided for storing allocation data indicative of the composition of the stored calibration data.

The different kinds of stored calibration data are illustrated schematically in FIG. 4 as fields. As an example, we may assume that the calibration data stored in field 411 is indicative of pixel defects; the calibration data stored in field 412 is indicative of lens shading; and calibration data stored in field 413 is indicative of spectral responsiveness, which as a term can for practical purposes be equated with the term sensitivity.

Further parts of the apparatus that are schematically illustrated in FIG. 4 are a pixelized image sensor 421; a lens 422 configured to focus incident electromagnetic radiation onto said image sensor 421; a mechanical shutter 423 configured to controllably allow incident electromagnetic radiation to reach said image sensor 421 or keep incident electromagnetic radiation from reaching said image sensor 421; and a zooming mechanism 424 configured to change a focal length of said lens. Many of these parts are such that they are not necessarily present in all electronic imaging modules or devices. For example, it is possible to do without a mechanical shutter, because other ways are known to regulate the ways in which electromagnetic radiation will be registered by the image sensor. Similarly it is possible to do without a zooming mechanism, because imaging can be performed with a fixed focal length and also because other ways are known to achieve the zooming effect than mechanical zooming.

For comparison, FIG. 5 illustrates an electronic imaging device 301 that comprises an electronic imaging module 321 with an integral pixelized image sensor 421, lens 422, mechanical shutter 423 and zooming mechanism 424. The calibration memory 311 is internal to the electronic imaging device 301 but external to the electronic imaging module 321, and comprises the at least one register 501 and the fields 511, 512, and 513 for storing different kinds of allocation data. Here also it must be noted that the illustrates parts of the electronic imaging device are exemplary and different electronic imaging devices may comprise them in various constellations.

The contents of the at least one register 401 or 501 may be called a dynamic memory map. In the following we give a non-limiting example of what kind of contents a dynamic memory map might have. Especially the memory addresses and the designations of various parameters should be construed in a very exemplary, non-limiting sense.

An indicator of the so-called memory map version could be used, the most significant bits of which represent a major version number and the least significant bits of which represent a minor version number. It is advantageous to always have the memory map version at a fixed address.

An indicator of the so-called memory map configuration could be used. Exemplary meanings that the bits of this value may have include, but are not limited to, the existence/non-existence of mechanical shutter calibration data, the existence/non-existence of ND (neutral density) filter calibration data, the potential availability of sensitivity data, the potential availability of lens shading data, the potential availability of pixel defect data, the existence/non-existence of zoom and autofocus calibration data, and the potential availability of extensions to configuration data.

An indicator of the currently used memory map addressing scheme could be used. This indicator could be used to point out the starting addresses of various different types of calibration data. Together with the indicator of the memory map configuration, the indicator of the currently used memory map addressing scheme provide an advantageous way for the operating software to find shortcuts to some particularly needed calibration data. Mechanical shutter calibration data could be used to indicate a delay in suitable time units, like microseconds, from the occurrence of a shutter operating signal to the moment when the mechanical shutter has reached a predetermined position, like half closed or half opened. Mechanical shutter data naturally applies only to electronic imaging modules and devices that comprise a mechanical shutter.

Neutral density filter calibration data could be used to indicate the transparency of the ND filter. A predetermined equation is used to calculate the ND filter transparency value, which is stored in the calibration memory as ND filter calibration data.

A sensor sensitivity configuration indicator could be used to announce, in how many color temperatures the sensor sensitivity values are measured. Sensor sensitivity could be expressed in various ways and stored as sensor sensitivity calibration data. The number of bits used for pixel values in the sensor have an effect on how many bits should be used for sensor sensitivity data. For example a 10 bit sensor might use 32 bits for sensitivity data, grouped to R, B, Gr and Gb sensitivity values of 8 bits each. It could be advantageous to also store illumination data of measurement conditions as calibration data together with the sensitivity calibration data.

A lens shading configuration indicator could be used to announce, in how many color temperatures and in how many lens positions the lens shading values are measured. Other exemplary lens shading related indicators are measurement grid area and grid configuration, illumination data of measurement conditions, lens position information of measurement conditions, and the actual color shading measurement data.

A defect map type indicator could be used to indicate, what types of defects (singlets, couplets, other . . . ) are mapped. An indicator of the number of found defects could be used to define the size of the defect maps in bits. For found pixel defects, the pixel addresses could be stored as pixel defect calibration data.

An autofocus configuration indicator could be used to announce, what kinds of autofocus related calibration data (e.g. only horizontal; up and/or down orientation for optical data; start of controllability, extensions to autofocus related calibration data; or others) is available. The actual autofocus related calibration data can be stored by using values as announced in the autofocus configuration indicator.

FIG. 6 illustrates an apparatus 601 according to one exemplary embodiment of the invention. This apparatus could be designated a calibration apparatus, because it is configured for use in controllably subjecting an imaging module and/or an electronic imaging device to a set of test conditions and recording calibration data. An electronic imaging module that is to be calibrated is illustrated as a device under test 602. At the time of calibrating the electronic imaging module may exist as a standalone device, or it may already be installed in an electronic imaging device, which in FIG. 6 appears as the host device 603.

The dashed line that extends from the host device 603 around the device under test 602 illustrates that for the purposes of the following discussion it is of minor interest, whether the calibration is made on a standalone or installed device.

Similarly whether or not the stimulus generator 604, the task of which is to generate the set of test conditions, is part of the calibration apparatus 601 is of minor importance. A measuring unit 605 is configured to measure a response of the device under test to the set of test conditions, in order to determine specific characteristics of the electronic imaging module, and to produce calibration data indicative of the measured response.

For implementing dynamic calibration data allocation there is a calibration data allocator 606 configured to receive calibration data and/or information indicative of the calibration data from the measurement unit 605, and configured to determine a specific allocation of storage space for at least one type of calibration data indicative of specific characteristics of an electronic imaging module. The calibration data allocator 606 is also configured to compose allocation data indicative of composition of said calibration data.

According to one exemplary embodiment, allocation data may comprise one, some, or all of those parameters that were discussed above as contents of a dynamic memory map. In other words, the allocation data constitutes a guide that tells, how the stored calibration data specific to a particular calibrated electronic imaging module should be read and interpreted.

There is also provided a calibration data writer 607 configured to store said calibration data, and an allocation data handler 608 configured to effect storing of said allocation data. Although these blocks are shown separately in FIG. 6, they could be a single block that is responsible for storing both calibration data and allocation data at a predetermined location. FIG. 6 illustrates four different basic alternatives of storing the calibration data and allocation data.

According to one embodiment, both the calibration data and the allocation data are stored into a calibration memory of the electronic imaging module, as is illustrated by the arrow going into the device under test 602 in FIG. 6. Such an embodiment has the advantage that a calibrated electronic imaging module is a self-contained unit, which carries along both its calibration data and the instructions of how to read and interpret its calibration data.

According to one embodiment, both the calibration data and the allocation data are stored into a memory of an electronic imaging device that comprises said electronic imaging module as an integral part. This is illustrated in FIG. 6 with an arrow that goes into the host device 603. Such an embodiment has the advantage that less memory capacity is required of the electronic imaging module.

According to one embodiment, both the calibration data and the allocation data are stored into a remote data storage 609 coupled to a data transmission network. As an example, the remote data storage 609 could be a data storage of an assembling plant, at which electronic imaging modules are installed into electronic imaging devices. As a part of the assembling process, appropriate calibration data and allocation data are recognized e.g. on the basis of a stored identifier of the electronic imaging module that was calibrated previously, and stored appropriately to a calibration memory of either the installed electronic imaging module or to a memory of the assembled electronic imaging device. One advantage of such an embodiment is that the party responsible for the assembling plant has full control of the process of writing the calibration data and allocation data to the appropriate storage location in an assembled electronic imaging device.

According to one embodiment the calibration data and the allocation data are stored in a calibration data logger 610 that constitutes a part of or is otherwise located in association with the calibration apparatus 601. Calibration data and allocation data logging can be performed parallelly with storing the same data to other locations, in order to have a backup copy available if needed.

It is not necessary to store the calibration data and allocation data at the same location. For example, it is possible to store calibration data into a memory of an electronic imaging module and the allocation data to a memory of the electronic imaging device to which the module is installed. For some occasions it could be advantageous to store the calibration data into the memory of an electronic imaging module but to only pass the allocation data to the remote data storage 609, from which it could be later obtained by the party who has legally assumed possession of the electronic imaging module e.g. to install it as a part of an electronic imaging device. An advantage of such an embodiment would be the fact that if an unauthorised party gets hold of the electronic imaging module in between, he would not know how to read and interpret its stored calibration data.

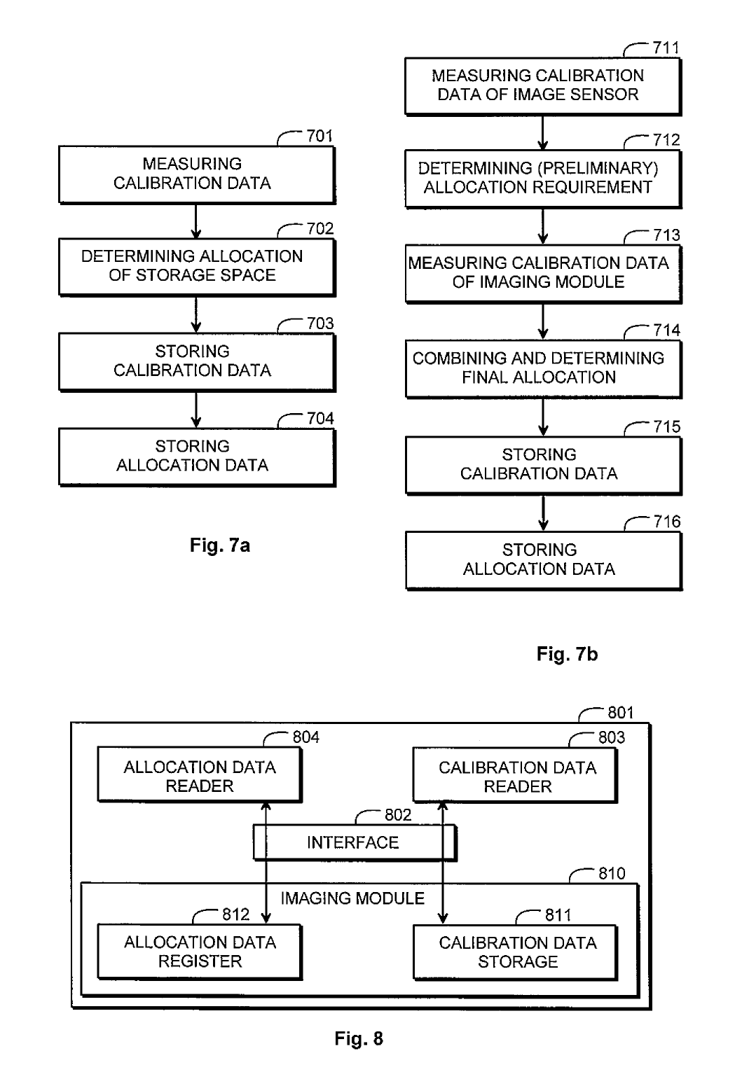

FIG. 7a illustrates a method according to an embodiment of the invention, but it can also be read as the description of software instructions that can be stored on a computer-readable medium and that, when executed on a processor, are configured to make the processor execute the method. Block 701 represents subjecting an electronic imaging module to a set of test conditions, measuring the response of the electronic imaging module and representing the measurement results in the form of calibration data. Block 702 represents determining a specific allocation of storage space for at least one type of calibration data indicative of specific characteristics of the electronic imaging module, and composing allocation data indicative of the composition of said calibration data. Block 703 represents storing said calibration data, and block 704 represents storing said allocation data. It is of no importance, in which order the allocation data and calibration data are stored.

Above in association with FIG. 6 there were discussed some exemplary possibilities of storing the calibration data and allocation data e.g. into a calibration memory of said electronic imaging module, into a memory of an electronic imaging device that comprises said electronic imaging module as an integral part, and/or into a remote data storage coupled to a data transmission network.

Some consideration may be given to the allocation strategy, i.e. what determines the course of dynamic allocation of storage space to calibration data, represented as block 702 in FIG. 7a. One possibility is to detect, how many pixel defects are found in said electronic imaging module. Storage space could then be allocated for pixel defect data, the amount of allocated storage space being equal to the number of found pixel defects multiplied with a predetermined number of bits. After that, a remaining part of the storage space could be allocated for calibration data other than pixel defect data, according to how much storage space was left over from a predetermined quota of storage space for calibration data after the storage space for pixel defect data was allocated. It should be noted that at least in a case where two types of defects are detected, it may be possible that the number of defects does not map exactly to a corresponding multiple of bits, because redundancy in e.g. defect location data can be utilized.

An alternative could be to start from the allocation of storage space to e.g. lens shading calibration data, and only use a remaining part of the predetermined quota of storage space for other calibration data, such as pixel defect calibration data.

The processes of measuring characteristics that should be described in calibration data, deciding the dynamic allocation of storage space to calibration data, and actually storing calibration data need not be tightly combined but can take place in a distributed manner and at various locations. An example of distributed generation and storing of allocation data and calibration data is illustrated in FIG. 7b.

FIG. 7b illustrates a method according to an embodiment of the invention, but it can also be read as the description of software instructions that can be stored on one or more computer-readable media and that, when executed on a processor or a number of processors in a distributed system, are configured to make the processor(s) execute the method.

Block 711 represents measuring calibration data related to an image sensor that may at this moment be a standalone component. As an example, a sensor manufacturer may examine the manufactured image sensors in order to locate pixel defects. The number and/or severity of pixel defects found in each individual image sensor may have an effect on how much storage space should be allocated in a calibration memory to the characterisation of pixel defects. Block 712 represents storing the measured image sensor specific calibration data temporarily in a storage device, and determining a preliminary allocation requirement of how much storage space should be allocated in a calibration memory to the characterisation of pixel defects.

Block 713 represents measuring “additional” calibration data, which is for example calibration data associated with a complete electronic imaging module. We may assume that the sensor manufacturer has delivered image sensors to the manufacturer of electronic imaging modules. In addition to the image sensors, the previously measured sensor specific calibration data are delivered. Identification data of individual sensors enables the module manufacturer to associate correct sensor specific calibration data with each image sensor.

After having assembled an electronic imaging module, the module manufacturer measures such calibration data that describe the characteristics of an assembled module. Block 714 represents combining the latest calibration data with previous (for example sensor specific) calibration data, and determining the final allocation of imaging module specific calibration data. Step 715 represents storing the combined, imaging module specific calibration data into calibration memory, and step 716 represents storing the final, imaging module specific allocation data that reveals, what are the dynamically allocated contents of the calibration memory and how they should be interpreted.

The principle of gradually accumulating calibration data that will eventually become part of the final, imaging module specific allocation data can naturally comprise a more complicated chain than that of FIG. 7b. For example, a lens manufacturer might measure lens-specific calibration data and deliver it together with the lenses to the imaging module manufacturer. The form and location in which the gradually accumulating calibration data are stored and conveyed for later utilisation in the chain is not important to the invention. Various solutions could be devised, ranging from tags that follow the components in the manufacturing process to servers where stored data can be later found based on some unique identifier of a particular component. If the module specific storage circuit that will eventually constitute the final calibration memory is erasable, it can be used to store preliminary calibration data earlier in the process, so that after the final allocation of calibration data has been decided, the calibration memory is erased of previous, preliminarily stored data (if required) and the final calibration data is stored therein according to the decided allocation.

FIG. 8 illustrates an apparatus 801, which can be e.g. an electronic imaging device. In order to properly utilize the dynamically allocated calibration data of an electronic imaging module 810, it is advantageous that the apparatus 801 comprises certain features.

There is provided an interface 802 for exchanging digital data with the electronic imaging module. There is also provided a calibration data reader 803 that is configured to read calibration data through said interface. Here we assume that calibration data has been stored in a calibration data storage (i.e. calibration memory) 811 of the electronic imaging module 810

There is also provided an allocation data reader 804 that is configured to read allocation data indicative of composition of said calibration data and to control the reading of said calibration data on the basis of read allocation data. In FIG. 8 we assume that also the allocation data has been stored in an allocation data register 812 of the electronic imaging module 810. However, as has been pointed out earlier, in some embodiments of the invention at least one of the calibration data and the allocation data may be stored to and read from a memory of the apparatus 801 that comprises the electronic imaging module 810 as an integral part.

The general principle of how to use calibration data for enhancing the quality of acquired digital images involves first acquiring a digital image and then processing the digital data that constitutes the electronic representation of the digital image, wherein said processing is guided by stored calibration data. For example, if calibration data shows that an electronic imaging module has a pixel defect at a particular location, it means that a digital image originally acquired with that electronic imaging module is likely to contain an erroneous, non-natural pixel value at the corresponding location. An image processing functionality may take this into account for example by first locating and erasing the erroneous pixel value through utilizing the stored identification of the pixel defect in the calibration data, and then generating and storing a new pixel value by e.g. calculating a mean value of pixels adjacent to the one that was erased. The same principle applies to all utilization of calibration data: after having read the calibration data an image processing functionality knows, which parts of the digital data that constitutes the electronic representation of the digital image should be corrected, and in which way. The corrective processing measures to be taken are typically relatively straightforward and involve generating and storing corrected data that is based on the original image data and on the contents of the calibration data.

From the viewpoint of the present invention it is not important, which physical apparatus contains the image processing functionality, the task of which is to perform the corrective image processing. Possible locations involve, but are not limited to, the electronic imaging module, the electronic imaging device, and an external device that obtains the digital data that constitutes the electronic representation of the digital image as well as the calibration data through a local information transfer link or a long-distance network connection, and performs the corrective image processing. The image processing functionality can also be distributed, for example so that some basic corrective image processing is performed in an electronic imaging module, and some more advanced corrective image processing, based on the same calibration data and/or some other parts of the stored calibration data, is performed in an electronic imaging device that acts as the host device of the electronic imaging module.

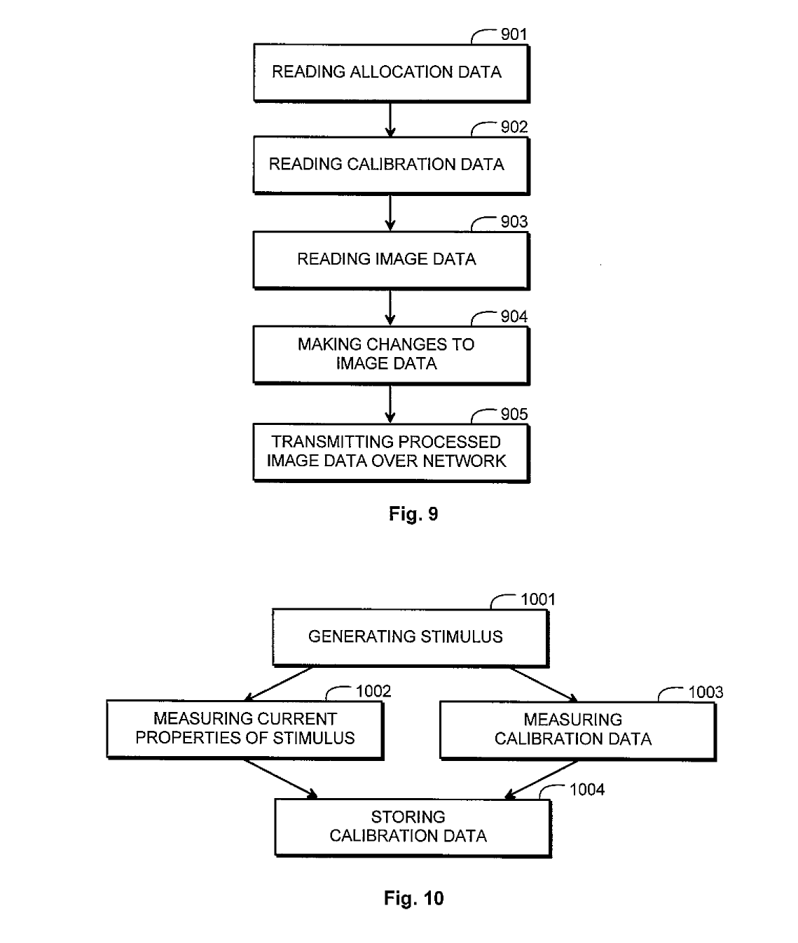

In the following we make an exemplary assumption that the image processing functionality is a part of the electronic imaging device of FIG. 8. The operation of an electronic imaging device can be illustrated in the form of a method. FIG. 9 illustrates a method according to an embodiment of the invention, but it can also be read as the description of software instructions that can be stored on a computer-readable medium and that, when executed on a processor, are configured to make the processor execute the method.

Step 901 represents reading allocation data indicative of composition of calibration data. The reason for this step is the need to determine, what has been the result of the dynamic allocation of storage space in the calibration memory during the calibration of this particular electronic imaging module, so that the calibration data can be correctly interpreted and utilized. Step 902 represents reading calibration data from a calibration memory associated with the imaging module in an order determined by said allocation data. In other words, based on the allocation data read in step 901, the various parts of calibration data can be read and registered as appropriate values that can be later utilized in corrective image processing.

Step 903 represents reading image data from the imaging module, and step 904 represents corrective image processing, i.e. making changes to said image data on the basis of said calibration data. Earlier in this description we have assumed that an electronic imaging device may comprise the capability of setting up and maintaining network connections, so as an exemplary way of utilizing the corrected image data there is provided a step 904 that represents transmitting processed image data over a network connection.

In yet another embodiment of the invention at least one of the calibration data and the allocation data may be stored to and read from a remote data storage coupled to a data transmission network. Such an embodiment could be utilized for example so that electronic imaging devices, which are capable of communicating with other devices through a data transmission network, are sold to consumers without their calibration data and/or without their allocation data. When the consumer switches on such an electronic imaging device, it may download the necessary calibration data and/or allocation data from said remote data storage through said data transmission network.

Next we will discuss certain ways of compensating for unintended fluctuations in calibration conditions. Above in the description of the calibration process it was pointed out that calibration frequently involves subjecting the device under test to a controlled stimulus of known properties, and measuring the response of the device under test to said controlled stimulus. Unintended errors and/or fluctuations in the properties of the controlled stimulus constitute a potential source of errors. As a simple example, if the calibration process should involve subjecting the device under test to the optical radiation emitted by a 6000 K light source, but this time the colour temperature of the light source happens to be for example 5800 K instead, the sensitivity values or lens shading information that will be stored as the calibration data concerning sensitivity and lens shading will not be completely correct. Taken that the so-called AWB correction (Automatic White Balance) is a critical part in any image reconstruction chain in order to obtain good colour quality, and that colour quality has been proven to be essential for overall perceived image quality, errors in calibration data concerning sensitivity may introduce error sources to the whole image processing chain that are difficult to mend or compensate for afterwards.

According to an exemplary embodiment of the invention there is provided a method, comprising:

measuring properties of a stimulus used to calibrate an imaging module, and

storing calibration data indicative of the measured properties of the stimulus into a calibration memory associated with said imaging module.

Especially if measuring the properties of a stimulus is performed continuously, or specifically for each calibration operation, it is possible to speak of the first recited method step as measuring the current properties of the stimulus. Here the term “current” is an adjective and means “actual” or “present”, and not a substantive for e.g. electric current. Just like in the previous embodiments of the invention, if a calibration memory is “associated with” an imaging module, it may physically be part of the same imaging module or it may physically reside somewhere else, however so that a unequivocal association exists for later retrieval of the information, which stored calibration data corresponds to which imaging module.

Concerning embodiments of the invention where monitoring of the stimulus and storing stimulus-related information are involved, it is not imperative that dynamic allocation of calibration memory is applied. The idea of using monitored (current) characteristics of the stimulus to enable advanced corrective processing of acquired images is likewise applicable to embodiments where static allocation of calibration memory is used.

According to another exemplary embodiment of the invention there is provided a calibration apparatus, comprising:

a stimulus generator configured to subject an imaging module to a stimulus,

a stimulus monitor configured to measure (current) properties of said stimulus, and

a calibration data writer configured to store calibration data indicative of a response to said stimulus of said imaging module as well as calibration data indicative of the measured properties of the stimulus into a calibration memory associated with said imaging module.

According to another exemplary embodiment of the invention there is provided a method, comprising:

reading calibration data from a calibration memory associated with an imaging module, said calibration data being indicative of a response of said imaging module to a stimulus,

reading reference data from a memory, said reference data being indicative of a response of a reference imaging module to a stimulus,

using said calibration data and said reference data to derive corrected calibration data indicative of a response of said electronic imaging module to a nominal stimulus,

reading image data from said imaging module, and

making changes to said image data on the basis of said corrected calibration data.

The embodiments of the invention listed in the foregoing paragraphs can be combined in many ways with embodiments described in the appended claims, for example so that selected features from what at the time of writing this description appears in depending claims can be combined with those described above.

FIG. 10 illustrates a method according to an embodiment of the invention, but it can also be read as the description of software instructions that can be stored on a computer-readable medium and that, when executed on a processor, are configured to make the processor execute the method. Block 1001 represents generating a stimulus, for example subjecting an imaging module to the optical radiation emitted by a light source in order to calibrate the imaging module. We may assume that the colour temperature of the light source should have a nominal value like 6000 K. Block 1002 represents measuring (current) properties of the stimulus in order to find out, what are the exact conditions that the imaging module under test experiences during calibration. For example, block 1002 may represent measuring the actual colour temperature of the light source during calibration, or so little earlier and/or after calibration that the actual colour temperature of the light source is unlikely to change significantly between the calibration instant and the measurement instant. If it is considered unlikely that the properties of the stimulus will not change very much over a number of calibration measurements, it is possible to measure the properties of the stimulus less often, for example once in an hour/day/week or the like.

The same principle of monitoring the (current) properties of the stimulus can be applied in various ways to various stimuli, but in order to emphasize the versatility of the invention we may consider the colour temperature case in more detail. When colour temperature is discussed, one usually means the so-called CCT (Correlated Colour Temperature), which can be expressed with a single value like 6000 K. However, a single colour temperature does not describe the chromaticity of the illumination unambiguously. For that reason it is in many cases more advantageous to describe the optical radiation used as a stimulus with the so-called CIE 1931 xy-coordinate, where CIE comes from the French expression Commission Internationale de l'Eclairage. Thus we may assume that in block 1002 at least the CIE 1931 xy coordinate of the optical stimulus is measured.

Block 1003 represents measuring the calibration data very much in the same way as in blocks 701, 711, and 713 described earlier in association with FIGS. 7a and 7b. Block 1004 represents storing the calibration data, which expression now covers both the value(s) indicative of the characteristics of the stimulus obtained in block 1002, and the value(s) indicative of the response to said stimulus of said imaging module obtained in block 1003. If the principle of monitoring the stimulus and storing associated calibration data is combined with the principle of dynamic allocation of calibration storage, the steps of determining allocation of storage space and storing allocation data should be included according to the model given in FIGS. 7a and 7b and their description.

FIG. 11 illustrates a calibration apparatus that can be used to implement the principle of measuring and storing values indicative of the (current) characteristics of a stimulus. The apparatus 1101 is in many respects similar to the one described earlier in association with FIG. 6, and the corresponding parts are described with the same reference designators.

As a difference, the measuring unit 1102 is equipped with a stimulus monitor configured to measure (current) properties of said stimulus, and the calibration data writer 1103 is configured to store both calibration data indicative of a response to said stimulus of the device under test 602 as well as calibration data indicative of the measured properties of the stimulus into a calibration memory associated with said device under test. The blocks 606 and 608 that are related to the dynamic allocation of calibration data storage are not essential in this case.

Describing the principle of utilizing information about (current) characteristics of a stimulus is concluded by describing, how such information can be used in an exemplary form of image processing. Before going into details we consider the principle of using reference data, and take again colour temperature as an example. If for example two CIE 1931 xy-coordinates are known, one of which describes the characteristics of the nominal stimulus and the other describes the characteristics of the actual stimulus, the relation between the two can be used in advanced AWB correction.

The aim of such advanced AWB correction is to use the actually obtained sensitivity-related calibration data to mathematically derive certain corrected calibration data, which represents an educated assumption of what the sensitivity-related calibration data would be if the sensitivity calibration had been performed with exactly the nominal stimulus. A practical implementation might involve measuring the sensitivity characteristics of a reference module at various colour temperatures and to scale an actual sensitivity value with the ratio (reference value at nominal stimulus)/(reference value at same stimulus at which the actual sensitivity value was obtained). In other words, the correction may be performed based on the measured response of the reference sensor sample for the nominal illumination and illuminations around the nominal illumination that cover the possible deviation of illumination chromaticity for that nominal illumination. Alternatively, the correction could be done based on spectral characterization of the reference sensor sample. Going briefly back to using just CCT as the indicator of colour temperature, we may assume that the sensitivity- or AWB-related calibration data of a reference module has been measured at 5800 K, 5850 K, 5900 K, 5950 K, 6000 K, 6050 K, 6100 K, 6150 K, and 6200 K. The resulting reference values have been stored, and are referred to here as ref_{—}5800K, ref_{—}5850K, . . . , ref_{—}6200K respectively. Next we assume that when a particular device under test was calibrated, the colour temperature of the optical stimulus was measured to be 5800 K. The calibration data value that was stored was thus something that we might call dut_{—}5800K, while the AWB algorithm that will be used expects a calibration data value at 6000 K as an input. In order to derive the required value dut_{—}6000K we make the calculation

dut_{—}6000K=(dut_{—}5800K/ref_{—}5800K)*ref_{—}6000K,

which represents the above-mentioned scaling of the actual sensitivity value (dut_{—}5800K) with the ratio of the reference value at nominal stimulus (ref_{—}6000K) over the reference value at same stimulus at which the actual sensitivity value was obtained (ref_{—}5800K). The same scaling principle can be used for many kinds of calibration data values, although it is not essential to the invention; other mapping methods exist also which a person skilled in the art might consider to derive a corrected calibration data value.

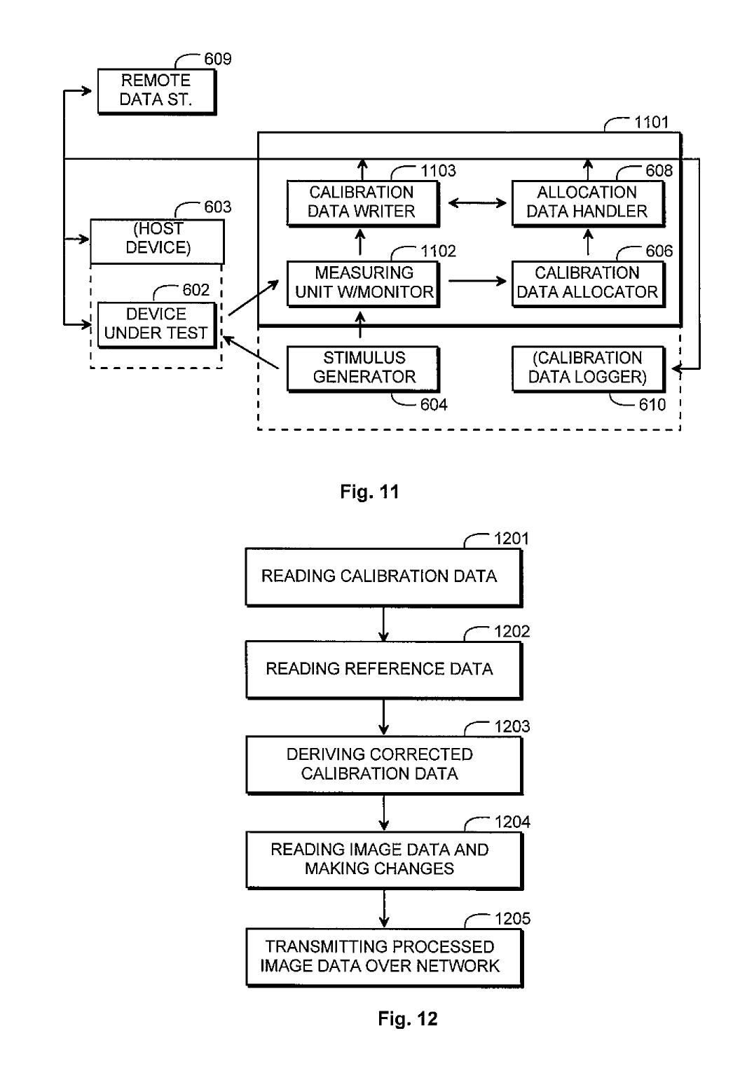

FIG. 12 illustrates a method according to an embodiment of the invention, but it can also be read as the description of software instructions that can be stored on a computer-readable medium and that, when executed on a processor, are configured to make the processor execute the method. Block 1201 represents reading stored calibration data from a calibration memory associated with an imaging module, said calibration data being indicative of a response of said imaging module to a stimulus (like the value dut_{—}5800K in the example above). Block 1202 represents using the information about the measured characteristics of the stimulus (i.e. the stored value 5800 K) to locate and read the appropriate reference data from a memory, said reference data being indicative of a response of a reference imaging module to a stimulus, like the value ref_{—}5800K in the example above.

Block 1203 represents using said calibration data and said reference data to derive corrected calibration data indicative of a response of said electronic imaging module to a nominal stimulus, for example by performing the scaling operation described above. Block 1204 represents reading image data from said imaging module and making changes to said image data on the basis of said corrected calibration data. Similarly to the example described earlier is association with FIG. 9, an optional step 1205 may follow in which the processed image data is transmitted over a network.

In the preceding explanation the term “sensitivity” has been used for simplicity. It should be noted that instead of saving actual sensitivity values of center, or the so-called R, Gr, B, and Gb values, also other kinds of indicators like R/G and BIG ratios could be stored. If the calibration of production models is performed at multiple temperatures, it is advantageous to repeat the stimulus monitoring and stimulus value storing steps at all temperatures. On the level of data fields in the calibration memory this means repeating fields like “sensor sensitivity” and “stimulus characteristics” as many times as there are colour temperatures at which calibration is performed. Performing calibration at more than one colour temperature typically increases significantly the achievable calibration accuracy.

In typical cases the calibration of an AWB algorithm is performed by doing colour calibration. This means a method or methods where information for calculating RIG (red/green) or B/G (blue/green) information is measured and stored. This information may be said ratio directly or sensitivity values of R, Gr, B, Gb, so that in the latter case the ratios can be calculated, or even the spectral response of the camera.

It is also beneficial to store brightness level (=lux level) as one characteristic of an optical stimulus, because that information can be used for example to calibrate the sensitivity of the camera module. In that case calibration sensitivity field could be also used to calibrate actual sensitivity of the module. It may be beneficial to also store the lens position information that indicates, at which position the lens was when calibration was performed.

In some cases, calibration values may change if lens positions change (e.g. if the imaging module comprises an optical zoom module or an auto focus module).

The foregoing explanation of exemplary embodiments should not be construed as limiting to the scope and applicability of the following claims. Features that are described in association with a particular embodiment can be combined and used in various ways together with other embodiments unless it is clear that a characteristic of some feature excludes any possibility of using it in any other embodiment.

We claim:

1. An apparatus comprising:
at least one processor;
memory storing a program of instructions;
where the memory storing the program of instructions is configured to, with the at least one processor, cause an apparatus to at least:
subject an electronic imaging module to a stimulus;
measure properties of said stimulus; and
store calibration data into a calibration memory associated with said electronic imaging module, the calibration data comprising calibration data indicative of a response to said stimulus of said electronic imaging module and calibration data indicative of the measured properties of the stimulus.

2. The apparatus of claim 1, wherein the apparatus is further caused to store reference data into a memory, and wherein the reference data comprises data indicative of responses of a reference imaging module to a nominal stimulus and to one or more reference stimuli and data indicative of said nominal stimulus and said one or more reference stimuli.

3. The apparatus of claim 2, wherein the reference data is stored in the calibration memory associated with said electronic imaging module.

4. The apparatus of claim 1, wherein measuring properties of said stimulus comprise measuring a colour temperature of a light source employed to generate said stimulus.

5. The apparatus of claim 1, wherein measuring properties of said stimulus comprises measuring a brightness level of said stimulus.

6. An apparatus according to claim 1, wherein said calibration memory associated with said electronic imaging module comprises at least one of the following:
calibration memory of said electronic imaging module;
memory of an electronic imaging device that comprises said electronic imaging module as an integral part; and
remote data storage coupled to a data transmission network.

7. The apparatus of claim 1, wherein the apparatus is further caused to determine a specific allocation of storage space for at least one type of calibration data indicative of specific characteristics of said electronic imaging module and to compose allocation data indicative of composition of said calibration data.

8. The apparatus of claim 7, wherein the apparatus is further caused to determine a specific allocation of storage space for calibration data that is indicative of at least one of a pixel defect, lens shading, or spectral responsiveness.

9. An apparatus comprising:
at least one processor;
memory storing a program of instructions;
where the memory storing the program of instructions is configured to, with the at least one processor, cause an apparatus to at least:
read calibration data from a calibration memory associated with an electronic imaging module, said calibration data being indicative of a response of said electronic imaging module to a stimulus;
read reference data from a memory, said reference data being indicative of a response of a reference imaging module to a stimulus; and
use said calibration data and said reference data to derive corrected calibration data indicative of a response of said electronic imaging module to a nominal stimulus;
read image data from said electronic imaging module; and
make changes to said read image data based at least in part on said corrected calibration data.

10. The apparatus of claim 9, wherein the reference data comprises data indicative of responses of a reference imaging module to said nominal stimulus and to one or more reference stimuli and data indicative of said nominal stimulus and said one or more reference stimuli.

11. The apparatus of claim 10, wherein the apparatus is further caused to read the reference data from the calibration memory associated with said electronic imaging module.

12. The apparatus of claim 9, wherein the apparatus is further caused to read allocation data indicative of composition of said calibration data and to control the reading of said calibration data on the basis of read allocation data.

13. The apparatus of claim 12, wherein the apparatus is further caused to read the allocation data from a register of said electronic imaging module.

14. The apparatus of claim 12, wherein the apparatus is further caused to read the allocation data from a memory integral to the apparatus and external to said electronic imaging module.

15. A method comprising:
subjecting an electronic imaging module to a stimulus;
measuring properties of said stimulus; and
storing calibration data into a calibration memory associated with said electronic imaging module, the calibration data comprising calibration data indicative of a response to said stimulus of said electronic imaging module and calibration data indicative of the measured properties of the stimulus.

16. The method of claim 15, further comprising storing reference data into a memory, the reference data comprising data indicative of responses of a reference imaging module to a nominal stimulus and to one or more reference stimuli and data indicative of said nominal stimulus and said one or more reference stimuli.

17. The method of claim 15, wherein said properties of said stimulus comprise at least one of a colour temperature of a light source employed to generate said stimulus and a brightness level of said stimulus.

18. The method of claim 15, further comprising:
determining a specific allocation of storage space for at least one type of calibration data indicative of specific characteristics of said electronic imaging module; and
composing allocation data indicative of composition of said calibration data.

19. The method of claim 18, wherein the calibration data allocator is configured to determine a specific allocation of storage space for calibration data that is indicative of at least one of: a pixel defect, lens shading, spectral responsiveness.

20. A method comprising:
reading calibration data from a calibration memory associated with an electronic imaging module, said calibration data being indicative of a response of said electronic imaging module to a stimulus;
reading reference data from a memory, said reference data being indicative of a response of a reference imaging module to a stimulus;
using said calibration data and said reference data to derive corrected calibration data indicative of a response of said electronic imaging module to a nominal stimulus;
reading image data from said electronic imaging module; and
making changes in said read image data on the basis of said corrected calibration data.

21. The method of claim 20, wherein the reference data comprises data indicative of responses of a reference imaging module to said nominal stimulus and to one or more reference stimuli and data indicative of said nominal stimulus and said one or more reference stimuli.

22. The method of claim 20, further comprising:
reading allocation data indicative of composition of said calibration data and to control the reading of said calibration data on the basis of read allocation data.

23. A non-transitory computer-readable medium storing a program of instructions, execution of which by a processor configures an apparatus to at least:
subject an electronic imaging module to a stimulus;
measure properties of said stimulus; and
store calibration data into a calibration memory associated with said electronic imaging module, the calibration data comprising calibration data indicative of a response to said stimulus of said electronic imaging module and calibration data indicative of the measured properties of the stimulus.

24. A non-transitory computer-readable medium storing a program of instructions, execution of which by a processor configures an apparatus to at least:
read calibration data from a calibration memory associated with an electronic imaging module, said calibration data being indicative of a response of said electronic imaging module to a stimulus;
read reference data from a memory, said reference data being indicative of a response of a reference imaging module to a stimulus;
use said calibration data and said reference data to derive corrected calibration data indicative of a response of said electronic imaging module to a nominal stimulus;
read image data from said electronic imaging module; and
make changes in said read image data on the basis of said corrected calibration data.
